(19) United States
(12) Patent Application Publication
(10) Pub. No.: US 2006/0242792 A1
(43) Pub. Date: Nov. 2, 2006

(54) Fitting for fixing a doorwing

(75) Inventor: Michaela Kienle, Lisboa (PT)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Foremost International GmbH & Co. KG, Bergisch Gladbach (DE)

(21) Appl. No.: 11/401,221

(22) Filed: Apr. 11, 2006

(30) Foreign Application Priority Data
Apr. 11, 2005 (DE) 20 2005 005 777.0

(51) Int. Cl. E05D 5/02

(52) U.S. Cl. 16/252

(57) ABSTRACT

Fitting for fastening a door wing, especially a door wing of a shower partition made of glass, plastic or similar material, with a hinge of two hinge leaves joined together by means of a keybolt, wherein each hinge leaf features a fastening plate and a hinge eyelet. The hinge features a detent mechanism with locking profiles which hold the door wing in the default swing position. The locking profiles are provided on each of the two hinge leaves. The locking profiles are provided on the keybolt.

The invention refers to a fitting for fastening a door wing, especially a door wing of a shower partition made of glass, plastic or similar material, with a hinge preferably made of two hinge leaves joined together with a keybolt, wherein each hinge leaf features a fastening plate and a hinge eyelet, wherein the hinge features a detent mechanism for holding the door wing in the desired swing positions, with locking profiles and wherein the locking profiles are provided on each of the two preferable positions. Normally, such a fitting features a lower and an upper hinge that respectively support the door wing. It is the scope of the invention that one of the two hinges features the detent mechanism that holds the door wing in the desired swing position. In principle, it is also possible in the scope of the invention that both hinges feature this detent mechanism.

A fitting of the type described above, on which the invention is based, is already disclosed in EP 0 712 988 B1. Here, the detent mechanism features locking profiles on the perpendicular face surfaces of hinge eyelets associated with each other and coaxial with the keybolt. The one locking profile is provided on a splined catching sleeve, coaxially with the connection pin in the lower hinge eyelet. Also in the hinge eyelet of the upper hinge leaf is a catching sleeve fitted with splined locking profiles and the same catching sleeve protrudes out of the upper hinge eyelet. The catching sleeve in the lower hinge eyelet is supported with freedom to rotate in a predetermined angular range around the axis of the keybolt in the hinge eyelet. The keybolt is screwed in an internal thread of this catching sleeve, such that the catching sleeve is adjustable in height by rotating the keybolt. To rotate the catching sleeve in the lower hinge eyelet, the catching sleeve is provided with a radial nose, which is adjustable and fixable with the help of two opposite screws within a fitting recess. Although this familiar fitting has basically proven itself, it still features several disadvantages. Therefore, the hinge with the detent mechanism leaves a lot to be desired in regard to material strength or stability aspects. Moreover, the cross bracing of the door wing in different swing positions is associated with the application of relatively large force, so that swinging the door is uncomfortable. Furthermore, swinging the door wing with this familiar fitting is often associated with disturbing noise. Furthermore, the hinge with the detent mechanism involved in this familiar fitting exhibits several gaps and openings in which water can penetrate so that calcification can occur. Such disadvantageous water inlet can especially occur between the keybolt and the catching sleeve that holds the keybolt.

In contrast to this, the invention is based on the technical problem to specify a fitting of the type mentioned at the beginning, which satisfies all requirements in terms of material strength or stability, with which the above described disadvantages can be avoided when swinging the door wing and with which also undesired water inlet and calcification can be reduced or minimized to a reasonable extent.

To solve this technical problem, the invention proposes a fitting, of the type described at the beginning, characterized in that the first locking profiles are provided on the keybolt. It lies therefore within the scope of the invention that the first locking profiles are formed directly on the keybolt or integrated in the keybolt. The keybolt is preferably cylindrical in shape. Wherein the term “mounted state” is used in the following passage, the mounted state, or rather the completed-mounted state of the door wing on the fitting or on the hinge is meant. The following used terms “lower hinge leaf” and “upper hinge leaf” are based on this “mounted state” of the fitting or of both the hinge and door wing. The keybolt engages with one section in one hinge leaf, i.e. in the lower hinge leaf and with another section in the other hinge leaf, i.e. in the upper hinge leaf. Both are preferably connected together in this manner.

In the scope of the invention, it is essential that the keybolt is fixed in one hinge leaf, preferably in an opening, for instance, in a blind hole of this hinge leaf. It is furthermore in the scope of the invention that the keybolt in a mounted state is fixed in the lower hinge leaf. Being fixed in the hinge leaf thereby means especially that the keybolt is fixed in the hinge leaf or in the opening of the hinge leaf and cannot be simply pulled out of this opening. The keybolt can for instance be fixed in the prior mentioned hinge leaf via an arresting connection. According to the very preferred embodiment of the invention that is of special importance, however, the keybolt is fixed via a screw connection in the hinge leaf. According to this embodiment, the keybolt preferably features external threads with which it can be screwed into internal threads on the hinge leaf or in the mounted state. Preferably, an opening or blind hole in this hinge leaf is provided with internal threads. It is in the scope of the invention that a section of the keybolt in this hinge leaf is screwed in and the rest of the section of the keybolt protrudes out of this hinge leaf and engages in a mounted state in the second (upper) hinge leaf. Thereby, it is still in the scope of the invention that the keybolt in the other (upper) hinge leaf only engages loosely and hence is not fixed. According to an embodiment, the keybolt is hollow inside and preferably features an internal opening with a multiple of corners in which a multiple-edge tool, for instance a hexagon tool can engage. In this manner, the keybolt can be screwed easily in internal threads on the (lower) hinge leaf.

Preferably, the first locking profiles of the keybolt are arranged on one face surface of the keybolt. The locking profiles thereby are provided on the face surface protruding out of the lower hinge leaf. These locking profiles of the keybolt form the one or first part of the detent mechanism and the second part of the detent mechanism is provided in the form of locking profiles in the upper hinge leaf. The locking profiles are formed as wave peaks and wave troughs according to the very preferred embodiment of the invention, which, in the mounted state likewise enclose the complementary locking profiles of the other hinge leaf formed as wave peaks and wave troughs. The wave peaks are thereby preferably made relatively flat, so that the pitch on the wave peaks is not so large and consequently the cross bracing of the door wing does neither require great effort nor produce disturbing noise. The embodiment with wave peaks and wave troughs has especially proven itself. The wave peaks and wave troughs formed on the keybolt preferably run around the circumference of the keybolt. If the keybolt is made hollow internally according to the embodiment already explained above, then a ring runs preferably around the wave peaks and wave troughs over the circumference of the keybolt on the face surface of the keybolt. The locking profiles are especially arranged correspondingly, such that 45° and/or 90° positions of the door wing can be realized.

According to the very preferred embodiment that is of very special importance in the scope of the invention, the keybolt features at least a manipulating flank in or on its (in the mounted state) side surface in which a hinge leaf is fixed and at least a manipulation opening is provided in which the hinge eyelet of this hinge leaf can be pressurized by means of the manipulating flanks and the keybolt as a result is adjustable or rotatable. The manipulating flank is therefore located on the side surface or on the part of the cylinder jacket with which the keybolt is fixed or screwed in the one hinge leaf. Preferably, a plurality of manipulating flanks is distributed at equal distances over the circumference of the keybolt. The manipulating flanks are preferably implemented by means of manipulation recesses in the side surface in the cylinder jacket of the keybolt. Preferable are several, favored are four manipulation recesses distributed at equal distances over the circumference of the keybolt. Preferable are two manipulation openings arranged on opposite sides of the hinge eyelet. A manipulation opening is provided preferably perpendicular or essentially perpendicular to the longitudinal axis of the keybolt in the hinge eyelet. The manipulating flank is pressurized preferably with the help of a respectively build-in manipulating pin, especially with a manipulating screw in a manipulation opening. With the help of the above described manipulating elements, very effective fine adjustment of the keybolt is possible. In other words, the locking profiles of the keybolt can very accurately be brought to the desired position in this manner or precisely adjusted.

A preferred embodiment of the invention is characterized in that the complementary locking profiles of the locking profiles of the keybolt are formed on a catching sleeve that is contained in a splined sleeve opening of a hinge leaf. This therefore involves a separate catching sleeve that is fitted in the assigned hinge leaf and splined (in the mounted state) in this sleeve opening of the hinge leaf. In the mounted state the face surface of the keybolt with its locking profiles lies on the locking profiles of the catching sleeve. The first locking profiles of the keybolt engage therefore in the complementary second locking profiles in the catching sleeve. According to the above explained preferred embodiment the wave peaks engage in wave troughs.

Preferably, the second locking profiles of the catching sleeve are fully contained in the sleeve opening of the assigned hinge leaf. In other words, the second locking profiles do not protrude out of this sleeve opening and the catching sleeve disappears (in the mounted state) in the sleeve opening.

According to the preferred embodiment of the invention, the catching sleeve features safety elements for ensuring splined holding in the assigned hinge leaf, wherein these safety elements are formed accordingly such that the catching sleeve is applicable in different angular positions in the sleeve opening. The catching sleeve can therefore be fitted in different positions, relatively displaced from one another, inside the sleeve opening of the assigned hinge leaf. In this manner, further adjustment of the hinge is also possible.

According to the particularly preferred embodiment of the invention, the two hinges are preferably made of brass. At least the fastening plates and hinge eyelets are preferably made of brass. Brass has particularly proven itself in combination with the other features according to the invention. According to the preferred embodiment of the invention also the keybolt and/or the catching sleeve are made of brass.

The invention is based on the knowledge that the hinge with the detent mechanism is especially characterized by especially high material strength or stability. Moreover, this door wing fitting according to the invention can be safely, easily and comfortably brought into different swing positions during use. It is also of special importance in the scope of the invention that very precise adjustment of hinge elements is possible and thus the swing position of the door wing can be set very accurately. Thereby, it must be stressed that the set swing position also remains without large deviations for a long time. With the fitting according to the invention, especially also very quiet cross bracing of the door wing can be realized. Furthermore, the hinge with the detent mechanism does not feature undesired gaps or openings through which bothersome water could penetrate, which could especially cause calcification. Furthermore, to be highlighted is that the fitting according to the invention or the hinge with detent mechanism can be manufactured easily and cost effectively.

In the following, the invention is explained in detail on the basis of an illustrative drawing of an exemplary embodiment. The following are schematically depicted:

FIG. 1 a hinge according to the invention in an exploded illustration, partly in section,

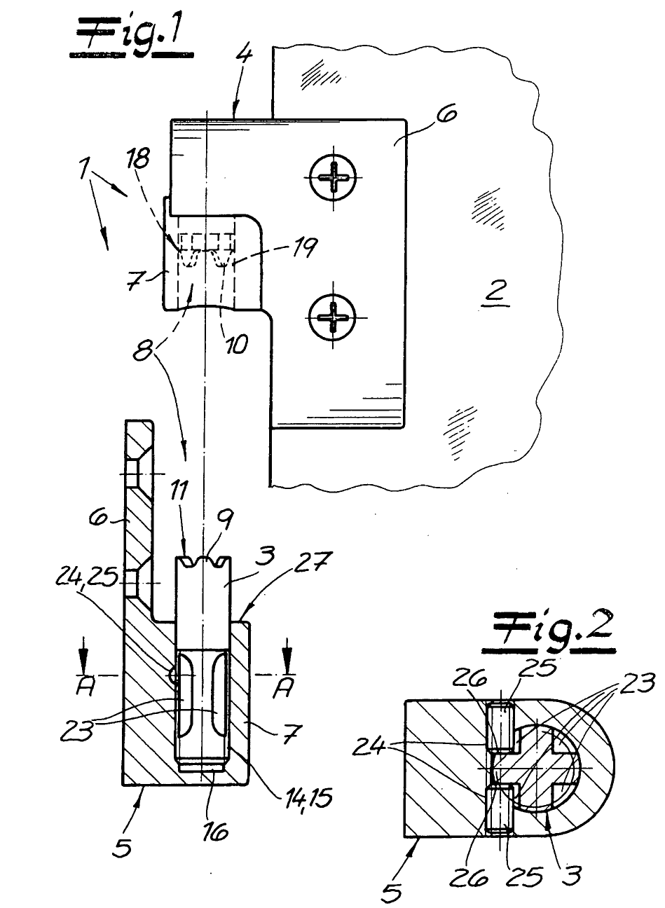

FIG. 2 a section A-A through the object according to FIG. 1,

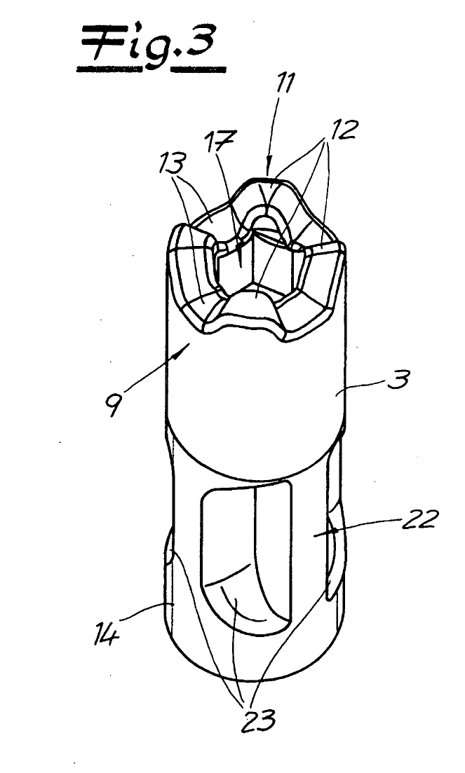

FIG. 3 a perspective depiction of the keybolt for the (in a mounted state) lower hinge leaf and

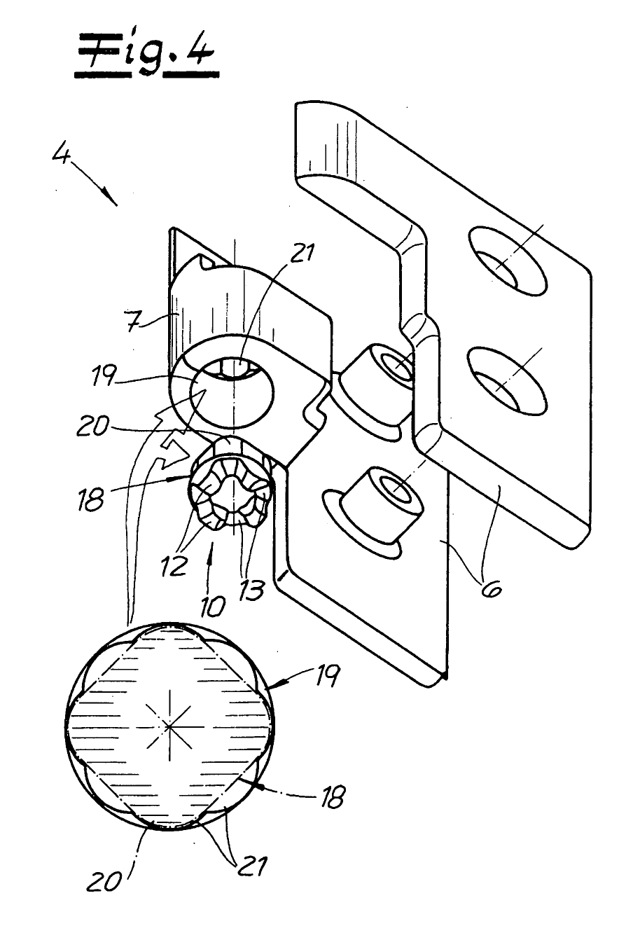

FIG. 4 a perspective depiction of the (in a mounted state) upper hinge leaf with associated catching sleeve

The figure depicts a hinge 1 according to the invention, which corresponds—in the mounted state—to the lower hinge 1 of a fitting for fastening a door wing 2. The door wing 2 especially consists of glass or plastic. The hinge 1 consists of two hinge leaves 4, 5 preferably joined together with a keybolt 3. Each hinge leaf 4, 5 features a fastening plate 6 and a hinge eyelet 7. The fastening plate 6 meant for the door wing 2 by itself comprises two parts joined together, which accommodate the door wing 2 between them (see especially FIGS. 1 and 4).

The hinge 1 according to the invention features a detent mechanism 8 with locking profiles 9, 10 that hold the door wing 2 in the desired swing position, wherein these locking profiles 9, 10 are provided on each of the two preferable hinge leaves 4, 5. The detent mechanism 8 is accordingly formed in the exemplary embodiment such that the door wing can be held in 45° or 90° positions. According to the invention, the locking profiles 9 are directly provided on the keybolt 3 and thus on a face surface 11 of the keybolt 3. The first locking profiles 9 are preferred and in the exemplary embodiment formed as wave peaks 12 and wave troughs 13 that preferably surround the circumference of the keybolt 3 and is preferably internally hollow in its upper section (see especially FIG. 3). The keybolt 3 in the lower hinge leaf 5 is permanently fixed. Furthermore, the keybolt 3 features an external thread 14, with which it can be screwed into an internal thread 15 of a blind hole 16 of the lower hinge leaf 5. According to a very preferred embodiment and in the exemplary embodiment, the keybolt 3 can be screwed directly in this blind hole 16 of the lower leaf 5.

The keybolt 3, preferably internally hollow in its upper area, preferably and in the exemplary embodiment (FIG. 3) exhibits an internal hole 17 with multiple edges, preferably hexagonal cross-section, so that it can be screwed from the top with a corresponding multiple-edge or hexagonal tool in the blind hole 16.

The second locking profiles 10 complementary to the first locking profiles 9 of the keybolt 3, which are provided on the upper hinge leaf 4, are formed on a catching sleeve 18 preferably and in the exemplary embodiment, which is received via splined connection in a sleeve opening 19 of the upper hinge leaf 4 (FIG. 4). Preferably and in the exemplary embodiment, the sleeve opening 19 of the upper hinge leaf 4 is accordingly formed such that the catching sleeve 18 with its second locking profiles 10 is fully received in this sleeve opening 19. The complementary second locking profiles 10 do not protrude from the sleeve opening 19. In the mounted state, the face surface 11 of the keybolt 3 with its first locking profiles 9 lies on the catching sleeve 18. Thereby, the wave peaks 12 on the face surface 11 of the keybolt 3 engage in the troughs 13 of the catching sleeve 18. To ensure the splined receptacle of the catching sleeve 18 in the upper hinge leaf 4, the catching sleeve 18 features securing ribs 20, which engage in complementary safety grooves 21 of the sleeve opening 19. It is recognizable (FIG. 4) that the securing ribs 20 or the safety grooves 21 are formed such that the catching sleeve 18 can be used in different angle positions in die sleeve opening 19. Therefore, preferably more safety grooves 21 than securing ribs 20 are provided and thus in the exemplary embodiment (FIG. 4) double as many safety grooves 21. The catching sleeve 18 can also be used in different positions in the sleeve opening 9. In this manner, adjusting or positioning of the locking profiles 10 is possible.

Especially in FIG. 3, it is recognizable that keybolt 3 features four manipulation recesses on its side surface 22 that engage in the lower hinge leaf 5 or in the blind hole 16. Through these manipulation recesses 23 manipulating flanks 26 occur, which can be pressurized by the manipulation openings 24 in the lower hinge leaf 5. In FIG. 2, it is recognizable that in the lower hinge leaf 5, two opposite manipulation openings 24 are formed, in which manipulating screws 25 are provided, with whose help one can act on the manipulating flank 26 of the keybolt 3. When screwing the keybolt 3 into the blind hole 16 of the lower hinge leaf 5, first adjustment or positioning of the first locking profile 9 of the keybolt 3 can be performed. With the help of the manipulating screws 25 or the manipulating flank 26, fine adjustment or fine positioning of the first locking profiles 9 can then be carried out.

In the figures, it is not recognizable that according to the preferred embodiment of the invention, the hinge surfaces 27, arranged near the opening of the blind hole 16, are slightly inclined accordingly so that water from the opening of the blind hole 16 is drained so that same cannot enter into the blind hole 16. This embodiment has especially proven itself in the scope of the invention, because in combination with the remaining features according to the invention, undesired water inlet into the interior of the hinge 1 can be prevented to a great extent and in so far also undesired calcification can be prevented.

1. Fitting for fastening a door wing (2), especially a door wing (2) of a shower partition made of glass, plastic or similar material, with a hinge (1) of two hinge leaves (4, 5) joined together by means of a keybolt (3), wherein each hinge leaf (4, 5) features a fastening plate (6) and a hinge eyelet (7), wherein the hinge (1) features a detent mechanism (8) with locking profiles (9, 10) which hold the door wing (2) in the default swing position, wherein the locking profiles (9, 10) are provided on each of the two hinge leaves (4, 5) characterized in that, the locking profiles (9) are provided on the keybolt (3).

2. Fitting according to claim 1 characterized in that the keybolt (3) is fixed in a hinge leaf (5).

3. Fitting according to claim 2 characterized in that the keybolt (3) features external threads (14), with the external threads (14) it can be screwed into the internal threads (15) of the hinge leaf (5).

4. Fitting according one of the claims 1 to 3 characterized in that the locking profiles (9) of the keybolt (3) are arranged on a face surface (11) of the keybolt (3).

5. Fitting according to one of the claims 1 to 4 characterized in that the keybolt (3), on its side surface (22) that engages in the one hinge leaf (5), features at least a manipulating flank (26) and that in the hinge eyelet (7) of this hinge leaf (5) at least one manipulation opening (24) is provided, through which the manipulating flank (26) can be pressurized and the keybolt (3) can be adjusted.

6. Fitting according to one of claims 1 to 5 characterized in that the complementary locking profiles (10) to the locking profiles (9) of the keybolt (3) are formed on a catching sleeve (18) whereby the catching sleeve (18) is accommodated in a splined sleeve opening (19) of a hinge leaf (4).

7. Fitting according to claim 6 characterized in that the complementary locking profiles (10) of the catching sleeve (18) are fully accommodated in the sleeve opening (19).

8. Fitting according to one of claim 6 or 7 characterized in that the catching sleeve (18) for ensuring a splined receptacle in the assigned hinge leaf (4) features safety elements and same safety elements are formed accordingly such that the catching sleeve (18) can be used in different angular positions in the sleeve opening (19).

9. Fitting according to one of claims 1 to 8 characterized in that both hinge leaves (4, 5) are essentially made of brass.
